(19) United States
(12) Patent Application Publication
(10) Pub. No.: US 2014/0074639 A1
(43) Pub. Date: Mar. 13, 2014

(54) METHOD AND APPARATUS FOR HOLISTIC MODELING OF USER ITEM RATING WITH TAG INFORMATION IN A RECOMMENDATION SYSTEM

(71) Applicant: Nokia Corporation, Espoo (FI)

(72) Inventors: Jilei Tian, Beijing (CN); Tengfei Bao, Beijing (CN); Happia Cao, Beijing (CN); Enhong Chen, Anhui (CN)

(73) Assignee: Nokia Corporation, Espoo (FI)

(21) Appl. No.: 14/116,839

(22) PCT Filed: May 16, 2011
(86) PCT No.: PCT/CN2011/074120

§ 371 Date: Nov. 11, 2013

(51) Int. Cl. G06Q 30/06

(52) U.S. Cl. CPC G06Q 30/0631
USPC 705/26.1

(57) ABSTRACT

An approach is provided for a holistic framework to model user item rating with user generated tag information. A tagging manager determines one or more tags associated with one or more items, wherein the one or more tags are generated by one or more users. The tagging manager processes and/or facilitates a processing of the one or more tags to cause, at least in part, a generation of one or more semantic spaces. The one or more semantic spaces and/or one or more semantic concepts within the one or more semantic spaces represent one or more groupings of the one or more tags. The tagging manager determines one or more probability parameters that the one or more tags, the one or more users, the one or more items, or a combination thereof are associated with respective ones of the one or more semantic concepts in the semantic spaces. The tagging manager then processes and/or facilitates a processing of the one or more probability parameters to cause, at least in part, a calculation of predicted rating information with respect to the one or more tags, the one or more users, the one or more items, or a combination thereof.

### BACKGROUND

Service providers and device manufacturers (e.g., wireless, cellular, etc.) are continually challenged to deliver value and convenience to consumers by, for example, providing compelling network services. One area of development has been the use of recommendation systems to provide users with suggestions or recommendations for content, items, etc. available within the services and/or related applications (e.g., recommendations regarding people, places, or things of interest such as companions, restaurants, stores, vacations, movies, video on demand, books, songs, software, articles, news, images, etc.). For example, a typical recommendation system may suggest an item to a user based on a prediction that the user would be interested in the item—even if that user has never considered the item before—by comparing the user's preferences to one or more reference characteristics based on, for example, collaborative filtering. Such traditional recommendation systems often rely exclusively on user-specified rating information (e.g., records on how individual users rate particular items of interest) to predict user interests and generate recommendations. Although user rating information is widely used for recommendations, other types of data (e.g., tags specified by users or associated with items) may be available as well. Accordingly, service providers and device manufacturers face significant technical challenges to enable recommendations that can account for different data types that are indicative of user interests and/or item features.

### Some Example Embodiments

Therefore, there is a need for modeling user and item tag information to, for instance, facilitate recommendations.

According to one embodiment, a method comprises determining one or more tags associated with one or more items, wherein the one or more tags are generated by one or more users. The method also comprises processing and/or facilitating a processing of the one or more tags to cause, at least in part, a generation of one or more semantic spaces. The one or more semantic spaces represent one or more groupings of the one or more tags. The method further comprises determining one or more probability parameters that the one or more tags, the one or more users, the one or more items, or a combination thereof are associated with the one or more semantic spaces. The method further comprises processing and/or facilitating a processing of the one or more probability parameters to cause, at least in part, a calculation of predicted rating information with respect to the one or more tags, the one or more users, the one or more items, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to determine one or more items, wherein the one or more tags are generated by one or more users. The apparatus is also caused to process and/or facilitate a processing of the one or more tags to cause, at least in part, a generation of one or more semantic spaces. The one or more semantic spaces represent one or more groupings of the one or more tags. The apparatus is further caused to determine one or more probability parameters that the one or more tags, the one or more users, the one or more items, or a combination thereof are associated with the one or more semantic spaces. The apparatus is further caused to process and/or facilitate a processing of the one or more probability parameters to cause, at least in part, a calculation of predicted rating information with respect to the one or more tags, the one or more users, the one or more items, or a combination thereof.

According to another embodiment, a computer-readable storage medium carries one or more sequences of one or more instructions which, when executed by one or more processors, cause, at least in part, an apparatus to determine one or more items, wherein the one or more tags are generated by one or more users. The apparatus is also caused to process and/or facilitate a processing of the one or more tags to cause, at least in part, a generation of one or more semantic spaces. The one or more semantic spaces represent one or more groupings of the one or more tags. The apparatus is further caused to determine one or more probability parameters that the one or more tags, the one or more users, the one or more items, or a combination thereof are associated with the one or more semantic spaces. The apparatus is further caused to process and/or facilitate a processing of the one or more probability parameters to cause, at least in part, a calculation of predicted rating information with respect to the one or more tags, the one or more users, the one or more items, or a combination thereof.

According to another embodiment, an apparatus comprises means for determining one or more items, wherein the one or more tags are generated by one or more users. The apparatus also comprises means for processing and/or facilitating a processing of the one or more tags to cause, at least in part, a generation of one or more semantic spaces, wherein the one or more semantic spaces represent one or more groupings of the one or more tags. The apparatus further comprises means for determining one or more probability parameters that the one or more tags, the one or more users, the one or more items, or a combination thereof are associated with the one or more semantic spaces. The apparatus further comprises means for processing and/or facilitating a processing of the one or more probability parameters to cause, at least in part, a calculation of predicted rating information with respect to the one or more tags, the one or more users, the one or more items, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-22 and 39-41.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of modeling user and item tag information for generating recommendations, according to one embodiment;

FIG. 2 is a diagram of the components of a recommendation engine, according to one embodiment;

FIG. 3 is an example architecture of a recommendation framework for supporting a tagging manager, according to one embodiment;

FIGS. 4A and 4B are diagrams of a semantic space for modeling user and item tag information, according to one embodiment;

FIG. 5 is a diagram of explaining semantic meaning and projecting tag spaces from a semantic space, according to one embodiment;

FIG. 6 is a flowchart of a process for modeling user and tag information, according to one embodiment;

FIG. 7 is a diagram of a user interface used in the processes FIGS. 1-6, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for modeling user and item tag information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

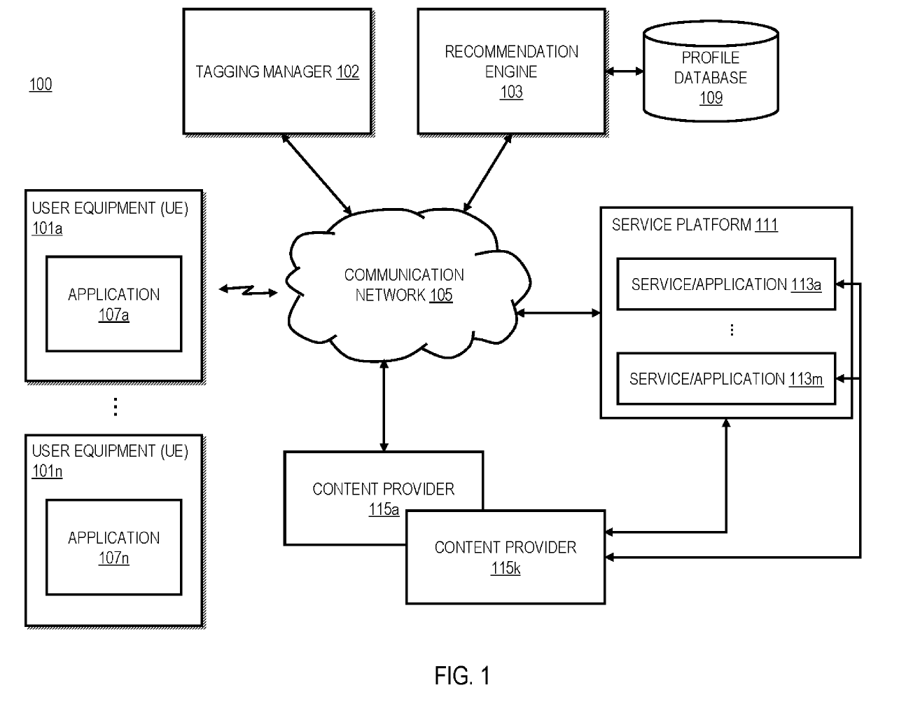

FIG. 1 is a diagram of a system capable of modeling user and item tag information for generating recommendations, according to one embodiment. Modern recommendation or recommender systems provide users with a number of advantages over traditional methods of search in that recommendation systems not only circumvent the time and effort of searching for items of interest, but they may also help users discover items that the users may not have found themselves. For example, recommendation systems address the problem of information overload by identifying user interests and providing personalized suggestions. By way of example, collaborative filtering (CF) is a core technology of most recommendation systems. In many cases, CF aims at predicting the preference of a user by using available ratings or taste information from many users. More formally, for example, given N users, M items, and an M×N preference matrix R, CF typically predicts the unknown rating information in R by using the available training ratings of R.

Recently, however, many recommendation systems enable users to provide or generate personalized tag information (e.g., keywords or phrases), in addition to ratings, when evaluating items. For example, some services enable a user to add keywords or tags (e.g., user generated tags) to annotate a referenced item. Consequently, through the growing popularity of tagging, many tags or tag information, which are associated with both users and items, have been collected. Often, this tag information can reflect both user interests and item topics or features. For example, if one user of a movie recommender system often annotates different items with tags as “Action” and “Comedy”, then it might be inferred that the user has a preference for action-comedy movies. In parallel, if the movies tagged by the user also tend to have predetermined tags (e.g., “Adventure” and “Sea”), the system might also infer a user preference in sea adventure movies. In other words, in addition to the user-item interaction (e.g., a user-item interaction), there are also user-tag interaction (e.g., a user's affinity to specify or prefer certain tags) and item-tag interaction (e.g., the tags most often assigned to an item).

Accordingly, a system 100 of FIG. 1 exploits such tag information to facilitate identification of user interests with respect to one or more items and improve recommendations. In one embodiment, the system 100 introduces a probabilistic model to explore both tag information and rating information in parallel. More specifically, the system 100 represents tags, users, and items in the same latent feature (or factor) space. By way of example, latent factors can be a type or a topic that can illustrate the users' preferences/interests, the items' features, and/or the tags' semantic meaning. Semantic meaning of tags is important, in this example, because tag data associated with users and/or items can be ambiguous. In other words, different tags can be used to mean the same thing, and the same tags can mean different things under different contexts. For example, the tags “American Movie” and “American” can both be used to tag a movie to indicate that the movie originates from the United States even though the tags are not identical (e.g., the tags are literally different but semantically the same). On the other hand, the tag “American” can represent a movie produced by the United States and can also represent a movie that is about the history of the United States (e.g., same literal tag, but different semantic meaning). Accordingly, the system 100 creates one or more semantic spaces that can group tags based on semantic meaning to improve modeling.

In some embodiments, the pairwise interactions (e.g., among the tags, users, and items) are modeled as the product of the pair of latent features within the one or more semantic spaces of tags. For example, in one embodiment, individual item-user interaction (e.g., a rating) is given as the product of the user feature vector and the item feature vector within the one or more semantic spaces. In one embodiment, the system 100 constructs at least three matrices (e.g., a user-tag matrix, an item-tag matrix, and a user-item rating matrix) to describe relationships among the tags, users, and/or items within the semantic spaces. In addition, the system 100 can, for instance, learn the low-dimensional latent features of tags, users, and items by simultaneously performing the low-rank approximations for the three matrices. In other embodiments, to avoid overfitting, the system 100 employs Gaussian priors to tag, user, and/or item vectors, which essentially lead to, for instance, l₂-regularization items in the objective function of the various embodiments described herein.

In one embodiment, the system 100 initiates the tag modeling process by representing user interests and/or item features in a tag space. In some embodiments, the tag space can be a projection of the semantic space. By way of example, the system 100 can represent the users and/or items with one or more tag distributions as actual counts (e.g., User u: tag 1: 20, tag 2: 30, . . . ; Item v: tag 1: 0, tag 2: 100, . . . ) or a normalization of the counts (e.g., User u: tag 1: 0.02, tag 2: 0.03, . . . ; Item v: tag 1: 0.00, tag 2: 0.07, . . . ). It is contemplated that the system 100 can use any normalization scheme to represent the tag distributions.

In another embodiment, the system 100 then models the user-tag, item-tag, user-item rating relationships within, e.g., a probabilistic matrix factorization model. More specifically, the system 100 maintains the user, item, and/or tag representations in semantic spaces. In this way, the user-tag, item-tag, and/or user-item ratings can be generated based, at least in part, on an inner product within the semantic spaces. As noted above, the users and items in the tag space are essentially projections from the semantic spaces.

In yet another embodiment, the system 100 can then estimate values of random variables (e.g., probability parameters) to represent respective probabilities that a particular user, item, tag, user-item rating, etc. are associated with a particular semantic space or a dimension within the semantic space. In some embodiments, the semantic spaces or dimension correspond to one or topics of tags that have been grouped based, at least in part, on the tags' semantic meanings. In one embodiment, the system 100 applies an estimation algorithm for the random variables or probability parameters (e.g., U representing a user, V representing an item, and T representing a user interaction with a tag). For example, when estimating U, V, and T, the estimation algorithm can select one of the variables for estimation and then fix the remaining various. In this way, the estimation problem is convex optimizable and can, for instance, be solved using a least squares iteration. In one embodiment, each variable can be estimated one at a time, with the process being iterated over the variables until a predetermined threshold is reached (e.g., a maximum number of iterations is reached).

In one embodiment, following estimation of the random variables or probability parameters, the system 100 can use the variables to predict rating information for various combinations of users and items, e.g., via the equation Rᵢⱼ=Uᵢ^{T}×Vⱼ where R is the predicted rating for a User U (1 through i) and Item V (1 through j).

In another embodiment, to give context and meaning to a rating, the system 100 can explain or define the meaning of each dimension in semantic space according to the tags grouped under the space or dimension. For example, the meaning of a dimension or semantic space is: S_{z}={t|Tₜ[z]εTop_{z}(K)}. Accordingly, to interpret the semantic meaning for a dimension z, the system 100 can use the top K tags in that semantic space dimension z.

In one embodiment, the system 100 can provide a recommendation engine for generating recommendation based, at least in part, on the various embodiments of the user and item tag information modeling described with respect to the various embodiments. In some embodiments, the recommendation engine is applicable to a plurality of applications or services, for instance, through the use of a schema (or schemas) (e.g., outlines, templates, rules, definitions, etc.) for collecting and sharing information among the applications to support generation of recommendation models (e.g., CF-based models). In one embodiment, the system 100 can use the schema for the purpose of specifying a format for content rating information as well as the tags for associating with users and/or items. As used herein, rating and/or tag information refers to data indicating how a user has rated an item within a particular application (e.g., representing user interaction information). In one embodiment, the rating and/or tag information may be explicitly provided (e.g., by specifying a number stars for a music track, thumbs up for a movie; or by specifying keywords, tags, etc.) or implicitly determined (e.g., based length of time an application item is used or accessed, frequency of use, previously used tags, etc.). The rating and/or tag information collected from the various applications can then be pooled, associated, etc. based on the schema discussed above. In this way, the system 100 may collect the content rating and/or tag information from one or more applications based on the schema for use in generating recommendation models for any of the participating applications, thereby maximizing the pool of available data (e.g., rating information) when compared to collecting information from only one application to support a standalone recommendation model. Under the various embodiments of the approach described herein, the pool of available data can be processed or mapped to a feature space to support feature-based CF.

In certain embodiments, the system 100 enables application developers to extend the schema to include new types of rating information and/or tags. For example, if the schema is defined using a structured language (e.g., eXtensible Markup Language (XML)), an application developer may extend the schema by adding a new namespace to represent the new type of rating information and/or tags. Accordingly, if one application cannot resolve or does not understand the new namespace, the namespace can be ignored. In addition or alternatively, if no schema is available to relate rating and/or tag information collected from multiple applications, the system 100 can apply, for instance, a semantic analysis to infer the relationships between one set of rating and/or tag information to another set. For example, rating/tag information for a music application may include ratings or tags that can be semantically linked to rating/tag information for an e-book application. In this way, if the system 100 has collected rating and/or tag information from both types of applications, the collective set of rating/tag information can still be semantically linked to enable the collective to support the generation of recommendation models for the respective applications or a new application such as recommending e-books or music according to collected data under the common framework of the system 100.

As previously discussed, the collected rating/tag information may be stored, for instance, in one or more profiles (e.g., profiles associated with users and/or application items) for later use by a recommendation engine and/or any of the participating applications. The rating/tag information can also represented in one or more semantic spaces as described above. A recommendation system (such as collaborative recommendation system) requires a recommendation model to provide recommendations. For example, the system 100 may receive a request to generate a recommendation model from a particular application and then may use the rating/tag information from the one or more profiles to generate the requested recommendation model. In a further embodiment, the system 100 may extract data from the rating/tag information collected from multiple applications based on a relevance of the data to the requesting application. The extracted data is then utilized in generating the content recommendation model for the requesting application. As such, applications may request recommendations models from the common framework or recommendation engine of the system 100 rather developing a separate recommendation framework or engine for each individual application. In this way, the system 100 advantageously enables sharing of the recommendation engine to reduce the computation, memory, bandwidth, storage, and other resource burdens associated with developing application specific recommendation models. Furthermore, the system 100 may provide complementary data for the requesting application that would not have been possible if the application were to collect the data on its own.

In addition to improving efficiency by using a common framework for generating recommendation models for multiple applications, the common framework of the system 100 enables the information collected from one or more applications to be used to generate a recommendation model for another application. For example, some subsets of data in the content rating/tag information may be relevant to a particular application and not other applications, while other subsets are relevant to the other applications, but not the particular application. Thus, the content rating/tag information may support the generation of a plurality of content recommendation models for a plurality of applications. Furthermore, the same content recommendation models may be reused in such an environment where the models are applicable to a plurality of applications. A circumstance where a previously generated content recommendation model for an application may be provided to other applications is, for instance, where there is some relationship between the application and the other applications that would indicate similar items and users (e.g., a jazz music blog and a jazz music store program).

More specifically, the system 100 may receive a request, at a recommendation engine, for generating a content recommendation model for an application, wherein the recommendation engine is applicable to a plurality of applications. The request may be received from or transmitted by the application for which the content recommendation model is to be generated. Moreover, the request may be made by one or more users (e.g., administrators, developers, regular users, etc.) of the application, for instance, to improve the recommendations produced by the application. The system 100 may then retrieve content rating information from one or more profiles associated with the application, one or more other applications, or a combination thereof. The system 100 may further generate the content recommendation model based on the content rating information.

As shown in FIG. 1, the system 100 comprises a user equipment (UE) 101 or multiple UEs 101a-101n (or UEs 101) having connectivity to a tagging manager 102 and a recommendation engine 103 via a communication network 105. A UE 101 may include or have access to an application 107 (or applications 107), which may comprise of client programs, services, or the like that may utilize a system to provide recommendations to users. In one embodiment, the tagging manager 102 can perform various embodiments of the user and item tag information modeling process described herein to facilitate generating recommendations via the recommendation engine 103.

As users utilize the applications 107 on their respective UEs 101, the recommendation engine 103 may collect content rating/tag information (e.g., data indicating how a user might rate or tag an item) from the applications 107. By way of example, content rating/tag information collection might include asking a user to rate an item on a scale of one through ten, asking a user to create a list of items that the user likes, observing items that the user views, obtaining a list of items that the user purchases, analyzing the user's viewing times of particular items, asking the user to select from a suggested list of tags, providing for free-form entry of tags, etc. Likewise, the recommendation engine 103 may also provide the applications 107 with content recommendation models based on the content rating/tag information that the applications 107 may utilize to produce intelligent recommendations to its users. As such, the recommendation engine 103 may include or be connected to a profile database 109 in order to access or store content rating/tag information. Within the profile database 109, the content rating/tag information may be stored or associated with, for instance, one or more respective user profiles. It is noted, however, that the profile database 109 may also contain other profile types, such as application profiles, item profiles, historical user-item ratings, etc.

As shown, the UEs 101, the tagging manager 102, and the recommendation engine 103 also have connectivity to a service platform 111 hosting one or more respective services/applications 113a-113m (also collectively referred to as services/applications 113), and content providers 115a-115k (also collectively referred to as content providers 115). In one embodiment, the services/applications 113a-113m comprise the server-side components corresponding to the applications 107a-107n operating within the UEs 101. In one embodiment, the service platform 111, the services/applications 113a-113m, the application 107a-107n, or a combination thereof have access to, provide, deliver, etc. one or more items associated with the content providers 115a-115k. In other words, content and/or items are delivered from the content providers 115a-115k to the applications 107a-107n or the UEs 101 through the service platform 111 and/or the services/applications 113a-113n.

In some cases, a developer of the services/applications 113a-113m and/or the applications 107a-107n may request that the recommendation engine 103 generate one or more recommendation models with respect to content or items obtained from the content providers 115a-115k by one or users or UEs 101. The developer may, for instance, transmit the request on behalf of the application 107 and/or the services/applications 113 to the recommendation engine 103 for the purpose of generating a recommendation model and/or populating the recommendation model with sufficient data in order for the application to provide user recommendations. After receiving the request for the recommendation model, the recommendation engine 103 may then retrieve content rating/tag information from one or more profiles associated with the application 107, the services/applications 113, one or more other applications, the users, the items, or a combination thereof.

The recommendation engine 103 may further generate the content recommendation model based on the content rating/tag information. Because the content rating/tag information may be derived from the one or more profiles associated with the application 107, the services/applications 113 and/or the one or more other applications, the generation of the content recommendation model is not limited only to profiles associated with the application 107 for which the generation request was made. Thus, even if the application 107 has few or no users, prior to the generation request, the recommendation engine 103 may still be able to generate a content recommendation model with enough data to produce accurate predictions with respect to suggesting items of interest to users.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In an embodiment where the recommendation engine 103 employs CF- and/or content-based recommendation technologies, a subset of the content rating information may be extracted based on a relevance to a particular application. In a further embodiment, the generation of the content recommendation model may also be based on the subset extracted from the content rating/tag information. By way of example, the content rating/tag information can be mapped from item-based content rating/tagging to feature-based content rating/tagging. In addition or alternatively, content rating/tagging may be provided directly for the features or categories of the items. In one sample use case, a movie streaming application may make a request for a content recommendation model to provide its users with recommendations. The relevant subset that may be extracted from the content rating/tag information may include all data associated with movies or films from the one or more profiles located, for instance, in the profile database 109. As a result, the application may not only obtain user profile information (e.g., user preferences) associated with films previously identified by the application, but also user profile information associated with films that were not known by the application prior to its request. If, for instance, the content recommendation model generated for the application indicates that many of its users would be interested in certain previously unknown movie titles, the application may automatically search and obtain these previously unknown movies. Accordingly, the application may recommend to its users these and other available movies based on the content recommendation model constructed from the relevant subset of the content rating/tag information.

In another embodiment, a schema is determined for specifying the content rating/tag information across multiple applications (e.g., applications 107, services/applications 113). The schema may be used to determine, for instance, the format or structure of the content rating/tag information with respect to users, items, user-item ratings, and/or other features. In one embodiment, the schema may specify one or more taxonomies for defining features. In this way, the features can be standardized across one or more classes of items. By way of example, the schema may define elements and attributes that may appear in the content rating/tag information, the order and number of element types, data types for elements and attributes, default or fixed values for elements and attributes, etc. Elements defined by the schema may include application classifications, item categories, rating types, users, relationships, keywords, terms, etc. In one sample use case, a basic or a skeleton schema for specifying the content rating/tag information may be predefined. However, application developers may be able to extend the basic or skeleton schema, for instance, by providing a new namespace. In yet another embodiment, the content rating/tag information is collected from the application, the one or more other applications, or a combination thereof based on the schema. In a further embodiment, the collected content rating/tag information is also stored based on the schema. In this way, the operations of the recommendation engine 103 are generally made more efficient. For example, the recommendation engine 103 may access data (e.g., the content rating/tag information) in the profile database 109 to generate new content recommendation models for any application without first having to figure out how to interpret the data since the schema is already provided.

In another embodiment, the collected content rating/tag information is aggregated in respective ones of the one or more profiles. As provided, the one or more profiles may include one or more user profiles. It is noted, however, that the profile database 109 may also contain other profile types, such as application profiles, item profiles, etc. By way of example, user profiles in the profile database 109 may include names, locations, age, gender, race/ethnicity, nationality, items viewed, item viewing times, items searched, items downloaded/uploaded, items purchased, items added to a wish list, shopping cart, or favorites list, items rated and how they were rated, previously used tags, favorite tags, etc. Accordingly, the one of more profiles may be accessed to provide the content rating/tag information to generate content recommendation models for one or more applications.

In another embodiment, one or more relationships between a first portion of the content rating/tag information associated with the application and a second portion of the content rating/tag information associated with at least one of the one or more other applications is determined. In yet another embodiment, the generation of the content recommendation model is further based on the one or more relationships. In one sample use case, the content rating/tag information may contain data associated with a movie streaming service and also data associated with an e-reader program. The recommendation engine 103, for instance, may determine that a relationship exists between data associated with the romance genre of the movie streaming service and data associated with the romance genre of the e-reader program. As a result, the content recommendation model generated based on the romance genre relationship may indicate, for instance, that users that like e-books and romance movies have similar interests as users that like movies and romance e-books. In a further embodiment, the determination of the one or more relationships is based on the schema, a semantic analysis of the content rating/tag information, or a combination thereof. By way of example, the determination of the relationships may be based on the schema if the relationships are defined in the schema, based on the semantic analysis if the relationships are absent from the schema, or based on both if some relationships are defined and others relationships are not. In one embodiment, the relationships may be defined in one or more semantic spaces sot that rating/tag information for corresponding users and/or items are projections from the one or more semantic spaces.

In another embodiment, the content recommendation model defines a matrix for predicting an anticipated rating and/or tagging for one or more items of the application relative to the one or more profiles or users. By way of example, the content recommendation model may define a user vs. item matrix, wherein the matrix indicates how each user might rate a particular item. In addition, the content recommendation model may define a user vs. feature matrix, wherein the matrix indicates how each user might rate or prefer a particular feature or category of the items. Other matrices may include a user-tag matrix and an item-tag matrix to represent tags associated with a particular user and/or item. In one embodiment, the indications of the ratings may be expressed, for instance, by a numerical value after each user profile variable (e.g., items viewed, item viewing times, items searched, items downloaded/uploaded, items purchased, items added to a wish list, shopping cart, or favorites list, items rated and how they were rated, etc.) has been computed after being assigned a determined weight based on the application and/or other criteria. In one embodiment, the numerical value can be normalized to a particular scale or range (e.g., a value between 0 and 1). The matrix may also provide the indications simply by presenting the variables to the application. In this way, the application may assign weights to each variable and compute how each user might rate the items based on the assigned variable weights.

In some embodiments, the recommendation model and/or the matrix may be generated based, at least in part, on one or more additional parameters specified by the requesting service, the recommendation engine 103, and/or another component of the system 100. For example, in one embodiment, the recommendation engine 103 can create a factorized recommendation model (e.g., in the case of a matrix factorization approach to collaborative filters for generating recommendations). A parameter used to create the factorized recommendation model is, for instance, the number of latent topics to include that would be used to model each matrix (e.g., user matrix, item matrix, feature matrix). This parameter (i.e., the number of latent topics) can either be determined by the recommendation engine 103 (e.g., if the information is available to the recommendation engine 103), provided by the requesting application or service as input parameters is its request to generate a recommendation engine, or a combination thereof. It is noted that the parameters are often dependent on the nature of the applications, service, items, etc. relevant to service and are often specific to a particular recommendation model.

In another embodiment, the content rating information supports generation of a plurality of content recommendation models. As provided, there are many instances where the content rating information may support the generation of a plurality of content recommendation models. In one sample use case, a movie streaming service may make a request for a content recommendation model to provide its users with recommendations. The recommendation engine 103 may extract a subset of the content rating information retrieved from the one or more profiles in the profile database 109 based on a relevance to the movie streaming service, such as data associated with movies. However, the retrieved content rating information may also contain subsets that are not pertinent to the movie streaming service, but may be applicable to other unrelated applications, such as an e-reader program, a dating service, or a vacation blog. Accordingly, the different subsets of the content rating/tag information may support the generation of more than one content recommendation model.

By way of example, the UE 101, the tagging manager 102, the recommendation engine 103, and the application 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the application 107 and the corresponding service platform 111, services 113a-113m, the content providers 115a-115k, or a combination thereof interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

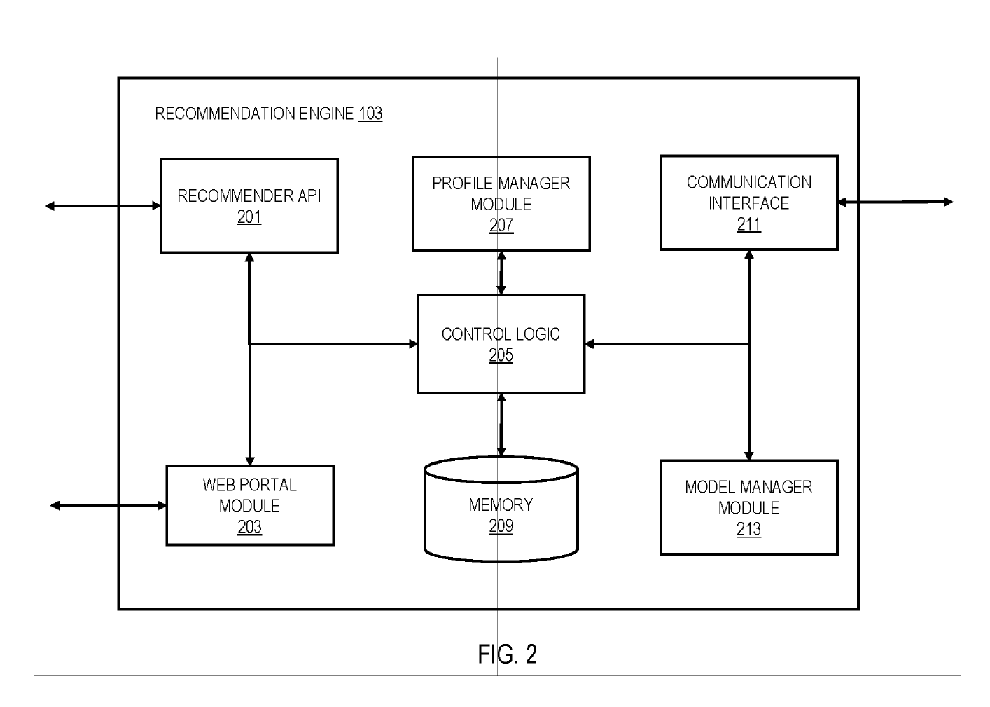

FIG. 2 is a diagram of the components of a recommendation engine, according to one embodiment. By way of example, the recommendation engine 103 includes one or more components for providing a framework for generating recommendation models based, at least in part, on tag information modeling provided by the tagging manager 102. It is contemplated that the functions of these components may be combined in one or more components or performed by other components of equivalent functionality. In this embodiment, the recommendation engine 103 includes a recommendation API 201, a web portal module 203, control logic 205, a memory 209, a communication interface 211, and a model manager module 213.

The control logic 205 can be utilized in controlling the execution of modules and interfaces of the recommendation engine 103. The program modules can be stored in the memory 209 while executing. The communication interface 211 can be utilized to interact with UEs 101 (e.g., via a communication network 105). Further, the control logic 205 may utilize the recommendation API 201 (e.g., in conjunction with the communication interface 211) to interact with the tagging manager 102 as well as with the applications 107, the service platform 111, the services/applications 113, other applications, platforms, and/or the like.

The communication interface 211 may include multiple means of communication. For example, the communication interface 211 may be able to communicate over SMS, internet protocol, instant messaging, voice sessions (e.g., via a phone network), or other types of communication. The communication interface 211 can be used by the control logic 205 to communicate with the UEs 101a-101n, and other devices. In some examples, the communication interface 211 is used to transmit and receive information using protocols and methods associated with the recommendation API 201.

By way of example, the web portal module 203 may be utilized to facilitate access to modules or components of the recommendation engine 103, for instance, by developers. Accordingly, the web portal module 203 may generate a webpage and/or a web access API to enable developers to test or register their applications with the recommendation engine 103. Developer may further utilize the web page and/or the web access API to transmit a request to recommendation engine 103 for the generation of content recommendation models for their applications.

Moreover, the profile manager module 207 may manage, store, or access data in the profile database 109. As such, the profile manager module 207 may determine how data from the content rating information should be stored or accessed (e.g., based on a schema). In addition, the model manager module 213 may handle the generation of content recommendation models. Thus, the model manager module 213 may interact with the profile manager module 207, via the control logic 205, to obtain the content rating information in order to generate the content recommendation models. As such, the model manager module 213 may further act as a filter in generating the content recommendation models from the content rating information such that data that does not meet certain criteria, such as relevance to a particular application, is not utilized in generating the content recommendation models.

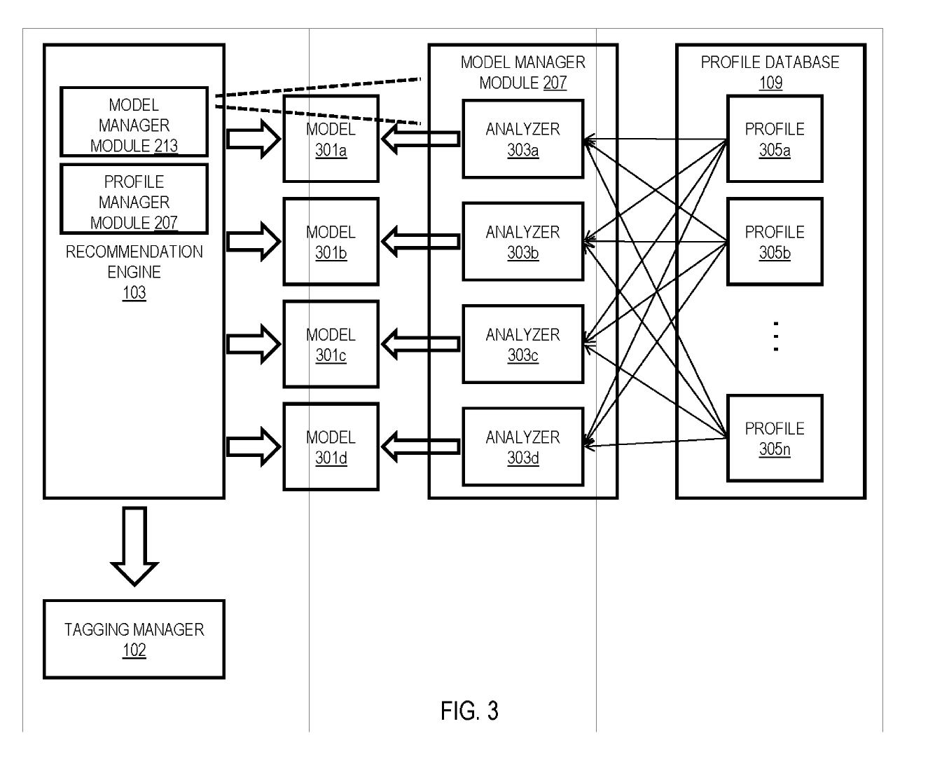

FIG. 3 is an example architecture of a recommendation framework for supporting a tagging manager 102, according to one embodiment. As shown, FIG. 3 presents the tagging manager 102, the recommendation engine 103, the profile database 109, the profile manager module 207, the model manager module 213, models 301a-301d, analyzers 303a-303d, and profiles 305a-305n. In this diagram, the recommendation engine 103 is simultaneously in the process of generating models 301a-301d (e.g., content recommendation models including both item-based CF models and feature-based CF models) for at least four different applications. As such, the recommendation engine 103 is applicable to a plurality of applications.

By way of example, when a request is received, at the recommendation engine 103, for generating a content recommendation model for an application, the recommendation engine 103 may retrieve, via the profile manager 207, content rating/tag information from profiles 305a-305n in the profile database 109. The profiles 305a-305n, as discussed above, may be associated with the application, one or more other applications, or a combination thereof. Thereafter, the recommendation engine 103, via the model manager module 213, generates the content recommendation model based on the content rating information. During this step, the model manager module 213 may filter out data that may be unnecessary for the generation of the content recommendation model using the analyzers 303a-303d. According, only a subset of the content rating/tag information may be extracted, for instance, based on a relevance to the application for the purpose of generating the content recommendation model. In addition, the analyzers 303a-303d may determine one or more relationships between a first portion of the content rating/tag information associated with the application and a second portion of the content rating/tag information associated with other applications for the purpose of generating the content recommendation model. To determine the relationships, the analyzers 303a-303b may rely on the schema and/or feature taxonomies used to specify the content rating/tag information and/or a semantic analysis of the content rating/tag information. In one embodiment, the analyzers 303a-303b may interact with the tagging information to determine the relationships, taxonomies, and/or semantic analysis. If, for example, the relationships and/or items-to-features mapping are defined in the schema, the relationship determinations and/or mappings may be based on the schema. If the relationships are absent from the schema, the relationship determinations and/or mappings may be based on the semantic analysis. If some relationships are defined in the schema and other relationships are not, the relationship determined may be based on both the schema and the semantic analysis.

Simultaneously, the recommendation engine 103 may collect additional content rating/tag information from the applications and/or the tagging manager 102 based, at least in part, on the schema used to specify the content rating information. In one embodiment, the additional content rating/tag information may be related to feature-based content rating/tagging whereby ratings/tags are provided for item features in addition to or instead of the items or users themselves. The recommendation engine 103, via the profile manager module 207, may then aggregate the collected content rating/tag information in the respective profiles 305a-305n in the profile database 109. On generating recommendations (e.g., including recommendation scores for a number of items), the recommendation engine 103 interacts with the tagging manager 102 to access modeling for tagging information to facilitate the generation of recommendations.

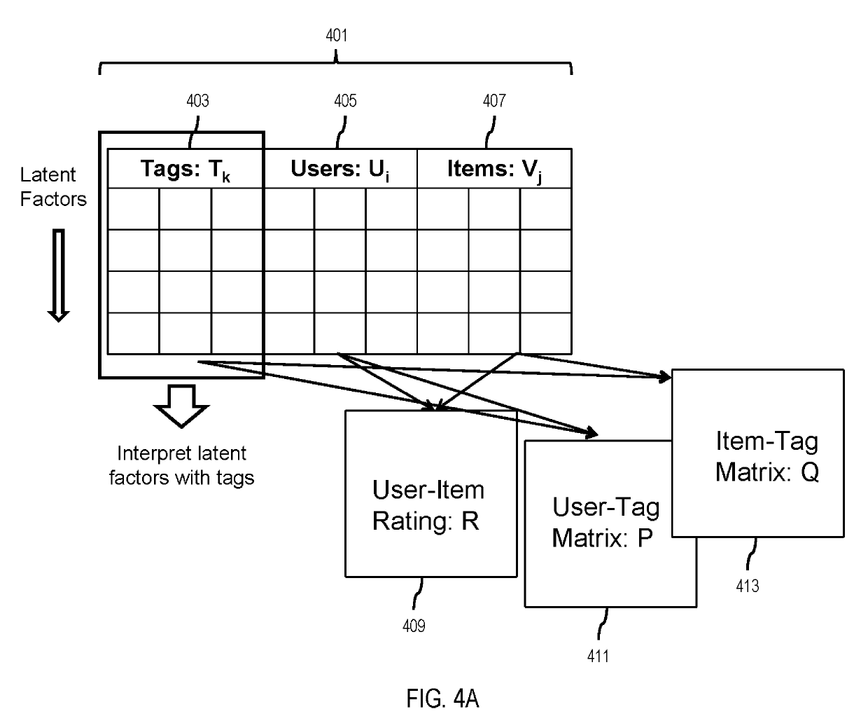

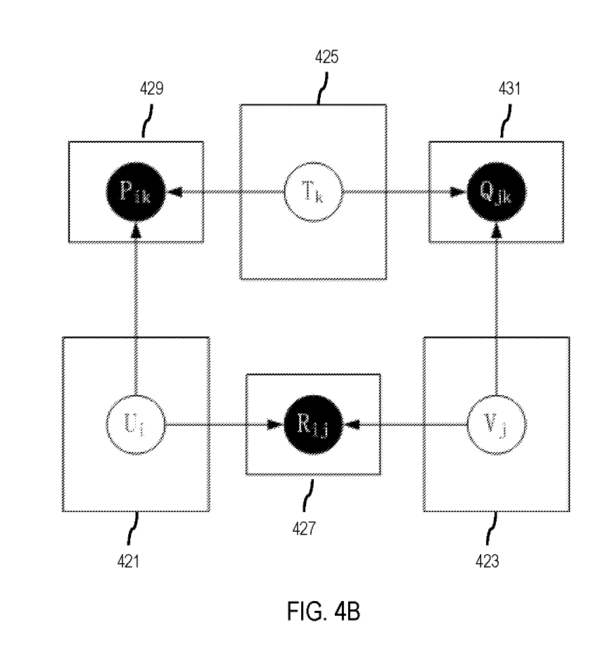

FIGS. 4A and 4B are diagrams of a semantic space for modeling user and item tag information, according to one embodiment. As shown in FIG. 4A, a semantic space 401 consists of a tag space 403 (e.g., including a k number of tags T), a user space 405 (e.g., including an i number of users U), and an item space 407 (e.g., including a j number of items V). The tag space 207 identifies tag and related information for determining the semantic meanings of the respective tags. As previously discussed, the tagging manager 102 can use the information in the tag space 207 to determine a number of latent factors and then interpret the meaning of the latent factors based, at least in part, in the distribution of tags associated with the respective latent factors. The user space 405 represents one or more users based, at least in part, on the distribution of tags associated with the each user. For example, the distribution represents a count of the number of observations of one or more tags that are associated with a particular user. In one embodiment, the tag count can increase based on, for instance, the number of times a user tags one or more items with the same tag. It is assumed that tags that occur more frequently with respect to a user are indicative of user preference. Similarly, the item space 407 represents one or more items with a distribution of tags that have been associated with a particular item. For example, it is assumed that a tag might be more highly correlated with an item if multiple users assign the item the same or similar tag.

In one embodiment, the tagging manager 102 can construct various matrices to represent relationships among the users, items, and tags of the semantic space 401. In one embodiment, these matrices include: (1) a user-item rating matrix R 409, where the elements of the matrix 409 provide rating information (predicted or actual) for users and items of the semantic space; (2) a user-tag matrix P 411, where the elements of the matrix 411 are random variables or probability parameters to indicate a likely association between a user and a tag; and (2) an item-tag matrix Q 413, where the elements of the elements of the matrix 413 are random variables or probability parameters to indicate a likely association between an item and a tag.

FIG. 4B depicts a graphical representation of the relationship among the users (represented by the variable Uᵢ 421), the items (represented by the variable Vⱼ 423), and the tags (represented by the variable Tₖ 425) of the semantic space 401. In one embodiment, a product of the Uᵢ 421 and Vⱼ 423 results in a rating Rᵢⱼ 427 that represents a predicted ration for user Uᵢ 421 with respect to an item Vⱼ 423. The rating Rᵢⱼ 427 is stored, for instance, as an element in the user-item matrix R 409.

A product of Uᵢ 421 and Tₖ 425 results in a probability Pᵢₖ 429 that the tag Tₖ 425 is representative of the user Uᵢ 421. The probability Pᵢₖ 429 is stored as an element in the user-tag matrix P 411. Similarly, a product of Vⱼ 423 and Tₖ 425 results in a probability Qⱼₖ 431 that the tag Tₖ 425 is representative of the item Vⱼ 423. The probability Qⱼₖ 431 is stored as an element in the item-tag matrix Q 413.

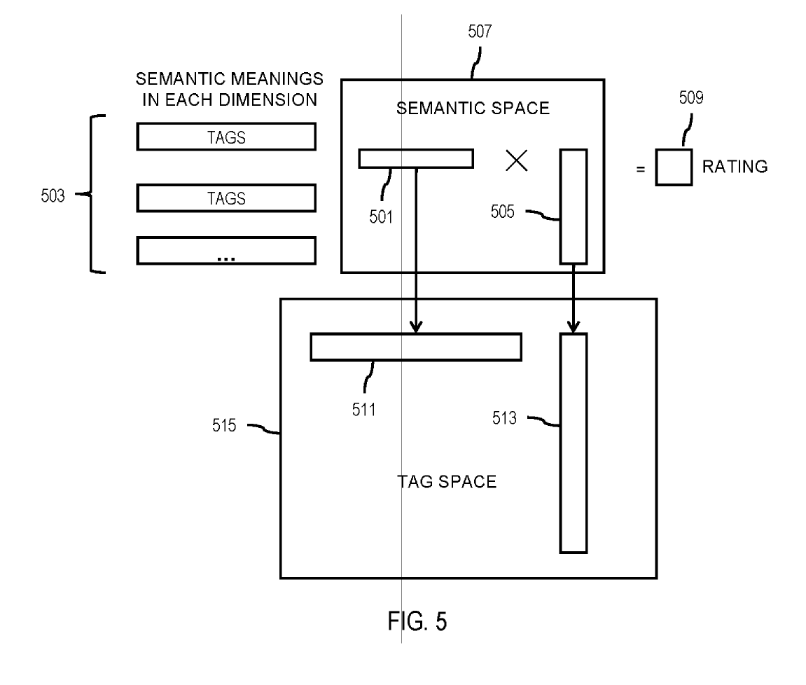

FIG. 5 is a diagram of explaining semantic meaning and projecting tag spaces from a semantic space, according to one embodiment. As shown in FIG. 5, the inner product of a user vector 501 (e.g., a vector representing the distribution of tags 503 associated with a user) and an item vector 503 (e.g., a vector representing the distribution of tags 503 associated with an item) in a semantic space 507 is a rating 509 (e.g., a predicted rating). In one embodiment, the meaning of the semantic space 507 is determined or explained by the set of tags 503 encompassed by the semantic space 507. For example, the set of tags 503 may describe or be related to one or more topics or categories bounded by the semantic space 507.

In one embodiment, the user distribution 511 is projected from the corresponding user vector 501 of semantic space 507 into the tag space 513, and the item distribution 515 is projected from the item vector 505 into the tag space 513.

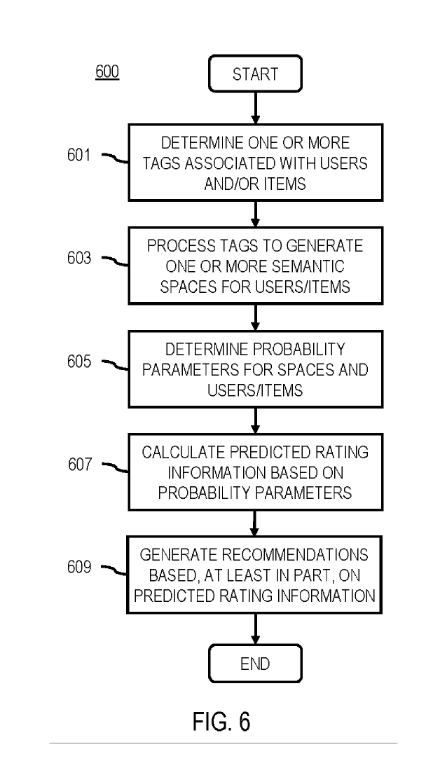

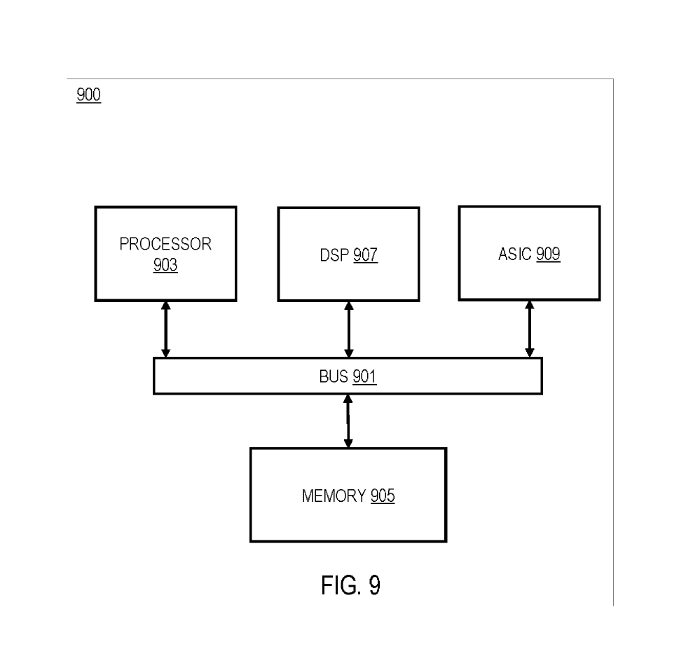

FIG. 6 is a flowchart of a process for modeling user and tag information, according to one embodiment. In one embodiment, the tagging manager 102 performs the process 600 and is implemented in, for instance, a chip set including a processor and a memory as shown in FIG. 9. In addition or alternatively, in some embodiments, it is contemplated that the recommendation engine 103 may perform all or a portion of the process 600.

In step 601, the tagging manager 102 determines one or more items, wherein the one or more tags are generated by one or more users, specified by the one or more users, or otherwise associated with the one or more users. Next, the tagging manager 102 processes and/or facilitates a processing of the one or more tags to cause, at least in part, a generation of one or more semantic spaces, wherein the one or more semantic spaces and/or semantic concepts within the one or more semantic spaces (e.g., semantic topics or meanings) represent one or more groupings of the one or more tags (step 603). In one embodiment, the tagging manager 102 processes and/or facilitates a processing of the one or more tags to determine one or more latent factors, wherein the one or more groupings are further based, at least in part, on the latent factors. By way of example, the determining of the one or more latent factors is based, at least in part, on a semantic analysis of the one or more tags.

In one embodiment, the users, items, and/or tags are represented in the same latent feature space (e.g., a semantic space 401), as described above with respect to FIGS. 4 and 5. Accordingly, the tagging manager 102 processes and/or facilitates a processing of the one or more tags, the one or more semantic spaces, or a combination thereof to cause, at least in part, a modeling of one or more user-tag relationships, one or more item-tag relationships, one or more user-item rating relationships, or a combination thereof, wherein the one or more probability parameters are based, at least in part, on the modeling. In some embodiments, the modeling is based, at least in part, on a probabilistic matrix factorization model. In yet another embodiment, the one or more user-tag relationships, the one or more item-tag relationships, the one or more user-item rating relationships are one or more projections of the one or more semantic spaces. In one embodiment, the relationships are represented as one or more interaction matrices as described with respect to FIGS. 4 and 5.

For example, given an observed user-tag interaction (e.g., user-tag matrix P 411), the tagging manager 102 assumes that a high value of Pᵢₖ 429 indicates that a high correspondence between user and tag latent features. More formally, the tagging manager 102 utilizes an inner product of Uᵢ 421 and Tₖ 425 (also referred to as Wₖ in the equations discussed below) to model the interaction between a user i and tag k. Thus the frequency of tag k used by the user i (e.g., Pik 429) is approximated as:

\hat{P}ᵢₖ=Uᵢ^{T}W

In another embodiment, the tagging manager 102 can assume Gaussian noise with a zero mean for the observed user-tag interaction matrix P 411. Accordingly, the conditional likelihood over the matrix P 411 can be derived as:

$$p ( P \vert U , W , {σ}_{P}^{2} ) = {\prod }_{i = 1}^{N} {\prod }_{k = 1}^{K} N ( {P}_{ik} \vert {U}_{i}^{T} {W}_{k} , {σ}_{P}^{2} )$$

In one embodiment, N(x|μ,σ²_{P}) denotes the probability density function of the Gaussian distribution with mean μ and variance σ²ₚ. In many cases, it is noted that many elements of the in the matrix P 411 may be 0 or have no values, which indicates that there is no interaction between users and tags. In some embodiments, such no interaction data can also be modeled to indicate the lack of interaction or correlation between the user and tag.

Similarly, for the item-tag interaction matrix Q 413, the tagging manager 102 can gain the conditional likelihood over the matrix Q 413 as:

$$p ( Q \vert V , W , {σ}_{Q}^{2} ) = {\prod }_{j = 1}^{M} {\prod }_{k = 1}^{K} N ( {Q}_{jk} \vert {V}_{j}^{T} {W}_{k} , {σ}_{Q}^{2} )$$

where, the tagging manager 102 use the inner product V^{T}ⱼ and Wₖ to model the interaction between item j and tag k, and place zero mean Gaussian noise. Moreover, in one embodiment, the tagging manager 102 assumes zero-mean spherical Gaussian priors onto tag feature vectors as:

$$p ( W \vert {σ}_{W}^{2} ) = {\prod }_{k = 1}^{K} N ( {W}_{k} \vert 0 , {σ}_{W}^{2} I )$$

In one embodiment, given the described linear modeling for interactions among each pair of user, item, and tag, the tagging manager 102 can simultaneously utilize both tag and rating information. In addition, the learning process can be done, for instance, by performing low-rank approximation for the observed three matrices: user-item matrix R 409, user-tag matrix P 411, and item-tag matrix Q 413. In this way, the user, item, and tag can be represented within the same latent feature space (e.g., semantic space 401). In one embodiment, the tagging manager 102 can derive the posterior distribution over user, item, and tag feature as:

P(U,V,W|R,P,Q,σ²_{R},σ²_{P},σ²_{Q},σ²_{U},σ²_{V},σ²_{W})∝P(R|U,V,σ²_{R})P(P|U,W,σ²_{P})P(Q|V,W,σ²_{Q})P(U|σ²_{U})P(V|σ²_{V})P(W|σ²_{W})

In yet another embodiment, the log of posterior distribution is given by:

$$ln P ( U , V , W \vert R , P , Q , {σ}_{R}^{2} , {σ}_{P}^{2} , {σ}_{Q}^{2} , {σ}_{U}^{2} , {σ}_{V}^{2} , {σ}_{W}^{2} ) ∝ ln P ( R \vert U , V , {σ}_{R}^{2} ) + ln P ( P \vert W , U , {σ}_{P}^{2} ) + ln P ( Q \vert W , V , {σ}_{Q}^{2} ) + ln P ( U \vert {σ}_{U}^{2} ) + ln P ( V \vert {σ}_{V}^{2} ) + ln P ( W \vert {σ}_{W}^{2} ) = - \frac{1}{2 {σ}_{R}^{2}} {\sum }_{i}^{ } {\sum }_{j}^{ } {I}_{ii} ( {R}_{ij} - {U}_{i}^{T} {V}_{j} ) - \frac{1}{2 {σ}_{P}^{2}} {\sum }_{i}^{ } {\sum }_{k} ( {P}_{ik} - {U}_{i}^{T} {W}_{k} ) - \frac{1}{2 {σ}_{Q}^{2}} {\sum }_{j}^{ } {\sum }_{k}^{ } ( {Q}_{jk} - {V}_{j}^{T} {W}_{k} ) - \frac{1}{2 {σ}_{U}^{2}} {\sum }_{i}^{ } {U}_{i}^{T} {U}_{i} - \frac{1}{2 {σ}_{V}^{2}} {\sum }_{j}^{ } {V}_{j}^{T} {V}_{j} - \frac{1}{2 {σ}_{W}^{2}} {\sum }_{k}^{ } {W}_{k}^{T} {W}_{k} - \frac{1}{2} ( NK ln {σ}_{P}^{2} + MK ln {σ}_{Q}^{2} + ( {\sum }_{i}^{ } {\sum }_{j}^{ } {I}_{ij} ) ln {σ}_{R}^{2} ) - \frac{1}{2} ( ND ln {σ}_{U}^{2} + MD ln {σ}_{V}^{2} + KD ln {σ}_{W}^{2} ) + C ,$$

where C is a constant which does not depend on parameters. Then, maximizing this log-posterior over user, item, and tag features with parameters (such as σ_{R} and σ_{U}) kept fixed is equivalent to minimizing the following objective function with quadratic penalty terms:

$$E = \frac{1}{2} {\sum }_{i}^{ } {\sum }_{j}^{ } {I}_{ij} ( {R}_{ij} - {U}_{i}^{T} {V}_{j} ) + \frac{{λ}_{P}}{2} {\sum }_{i}^{ } {\sum }_{k}^{ } ( {P}_{ik} - {U}_{i}^{T} {W}_{k} ) + \frac{{λ}_{Q}}{2} {\sum }_{j}^{ } {\sum }_{k}^{ } ( {Q}_{jk} - {V}_{j}^{T} {W}_{k} ) + \frac{{λ}_{U}}{2} {\sum }_{i}^{ } ‖ {U}_{i} ‖ + \frac{{λ}_{V}}{2} {\sum }_{j}^{ } ‖ {V}_{j} ‖ - \frac{{λ}_{T}}{2} {\sum }_{k}^{ } ‖ {W}_{k } ‖$$

In step 605, the tagging manager 102 determines one or more probability parameters that the one or more tags, the one or more users, the one or more items, or a combination thereof are associated with the one or more semantic spaces. As described above, in one embodiment, the tagging manager 102 determines a distribution of the one or more tags with respect to the one or more users, the one or more items, or a combination thereof, wherein the one or more probability parameters are based, at least in part, on the distribution, a normalization of the distribution, or a combination thereof.

In one embodiment, the tagging manager 102 determines to estimate at least one of the one or more probability parameters by fixing other ones of the probability parameters and applying at least one convex optimization. In some embodiments, the at least one convex optimization is based, at least in part, on a least squares iteration. For example, although the objective function above is convex in U only, V only, or W only, it is non-convex in U, V, and W together. Accordingly, canonical types of algorithms (e.g., alternating least squares (ALS) and Gradient Descent) can be applied to search the local minimal of the objective function. With respect to ALS, the tagging manager 102 alternatively solves the optimization problem by fixing two of the latent feature matrices and iteratively updating U, V, and W as:

$${U}_{i} = {( {\sum }_{j = 1}^{M} {V}_{j}^{T} {V}_{j} {I}_{ij} + {λ}_{P} {W}^{T} W + {λ}_{U} I )}^{- 1} \times ( {\sum }_{j = 1}^{M} {V}_{j} {R}_{ij} {I}_{ij} + {λ}_{P} {\sum }_{k = 1}^{K} {W}_{k}^{T} {P}_{ik} )$$

$${V}_{j} = {( {\sum }_{i = 1}^{N} {U}_{i}^{T} {U}_{i} {I}_{ij} + {λ}_{Q} {W}^{T} W + {λ}_{V} I )}^{- 1} \times ( {\sum }_{i = 1}^{N} {U}_{i} {R}_{ij} {I}_{ij} + {λ}_{Q} {\sum }_{k = 1}^{K} {W}_{k}^{T} {Q}_{jk} )$$

$${W}_{k}^{T} = {( {λ}_{P} {U}^{T} U + {λ}_{Q} {V}^{T} V + {λ}_{T} I )}^{- 1} \times ( {λ}_{P} {\sum }_{i = 1}^{N} {U}_{i} {P}_{ik} + {λ}_{Q} {\sum }_{j = 1}^{M} {V}_{j} {Q}_{jk} )$$

In step 607, the tagging manager 102 processes and/or facilitates a processing of the one or more probability parameters to cause, at least in part, a calculation of predicted rating information with respect to the one or more users, the one or more items, or a combination thereof. In one embodiment, the tagging manager 102 determines correlation information of the one or more tags to the one or more latent factors. The tagging manager 102 then causes, at least in part, a selection of at least one subset of the one or more tags to represent respective semantic meanings of the one or more semantic spaces, one or more dimensions of the one or more semantic spaces, or a combination thereof based, at least in part, on the correlation information. In other words, the tagging manager 102 can select representative tags to explain the meaning or topic bounded by the one or more semantic spaces.

In step 609, the tagging manager 102 determines to generate one or more recommendations based, at least in part, on the predicted rating information.

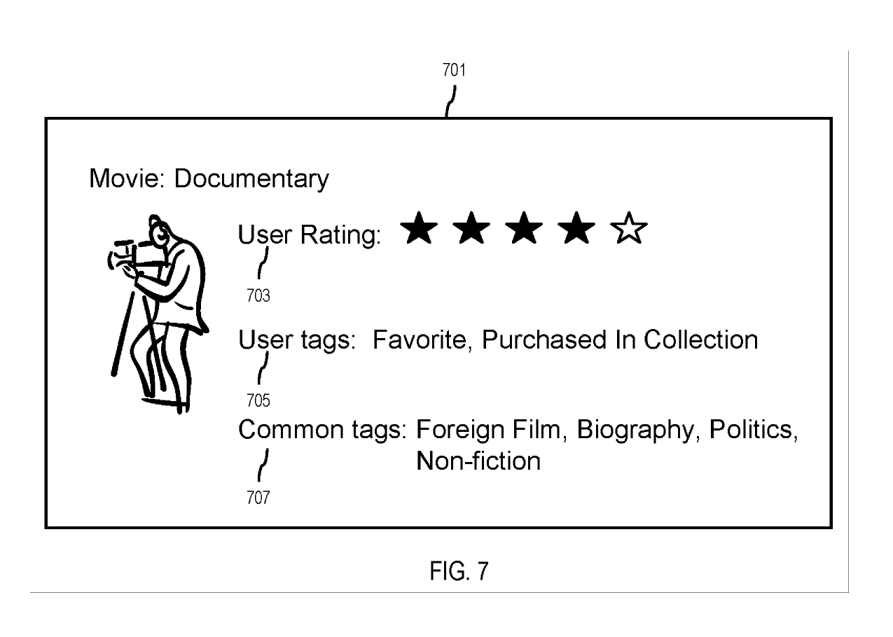

FIG. 7 is a diagram of a user interface used in the processes FIGS. 1-6, according to one embodiment. As shown, the UI 701 depicts a user interaction screen for providing rating and tag information for a content item (e.g., a movie). In this example, a user is asked to provide a rating 703 expressed as a scale of 1 to 5 stars. In addition, the user is requested to select one or more user tags 705. For example, the user has selected the “Favorite” and “Purchased In Collection” tags to describe the movie. In addition, the UI 701 can also present a set or predetermined or common tags 707 that have previously been associated with the movie.

In one embodiment, the tagging manager 102 can add both the user tags 705 and common tags 707 to a latent feature space (e.g., a semantic space 401). As a result, the user tags 705 and common tags 707 can be added to the tag distribution associated with the respective user and/or item (e.g., the movie). As previously described, the distribution and count of user-tag and item-tag interaction can be used to indicate user interests and/or item features, which can then be used to generate more semantically relevant or robust recommendations.

The processes described herein for modeling user and item tag information may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

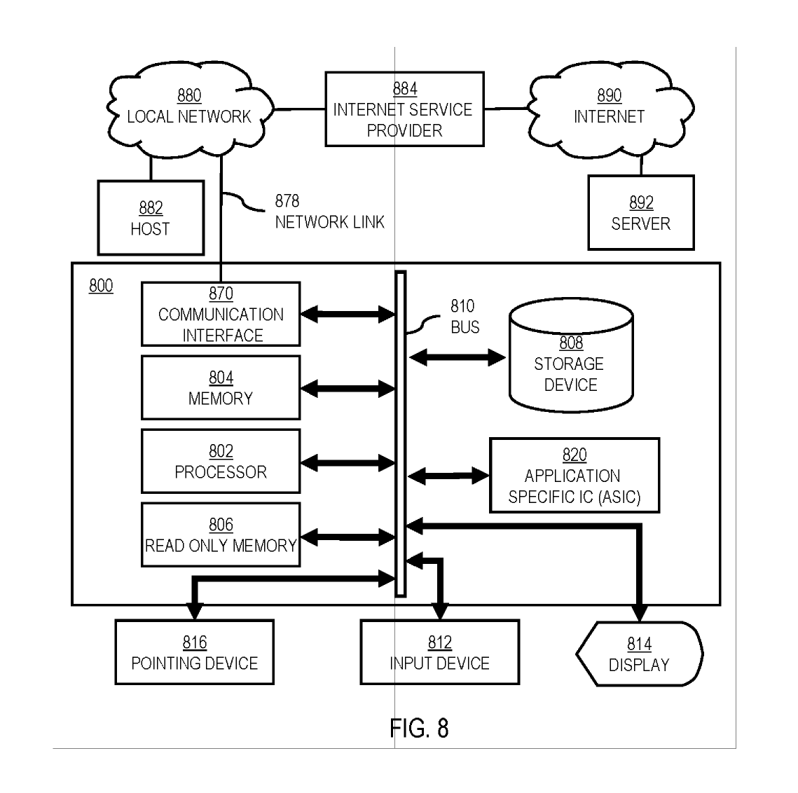

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to model user and item tag information as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of modeling user and item tag information.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to modeling user and item tag information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for modeling user and item tag information. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for modeling user and item tag information, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for modeling user and item tag information.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to model user and item tag information as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of modeling user and item tag information.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to model user and item tag information. The memory 905 also stores the data associated with or generated by the execution of the inventive steps.

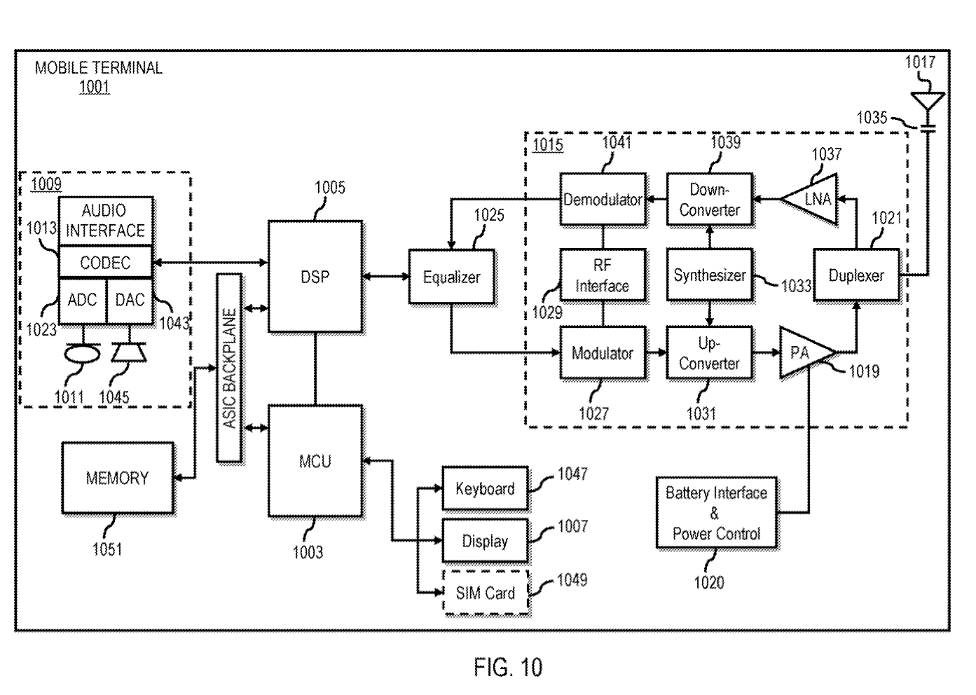

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of modeling user and item tag information. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of modeling user and item tag information. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to model user and item tag information. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-41. (canceled)

42. A method comprising facilitating a processing of and/or processing (1) data and/or (2) information and/or (3) at least one signal, the (1) data and/or (2) information and/or (3) at least one signal based, at least in part, on the following:
one or more tags associated with one or more items, wherein the one or more tags are generated by one or more users;
a processing of the one or more tags to cause, at least in part, a generation of one or more semantic spaces, wherein the one or more semantic spaces represent one or more groupings of the one or more tags;
at least one determination of one or more probability parameters that the one or more tags, the one or more users, the one or more items, or a combination thereof are associated with the one or more semantic spaces; and
a processing of the one or more probability parameters to cause, at least in part, a calculation of predicted rating information with respect to the one or more tags, the one or more users, the one or more items, or a combination thereof.

43. A method of claim 42, wherein the (1) data and/or (2) information and/or (3) at least one signal are further based, at least in part, on the following:
at least one determination to generate one or more recommendations based, at least in part, on the predicted rating information.

44. A method of claim 42, wherein the (1) data and/or (2) information and/or (3) at least one signal are further based, at least in part, on the following:
a processing of the one or more tags to determine one or more latent factors,
wherein the one or more groupings are further based, at least in part, on the latent factors.

45. A method of claim 44, wherein the at least one determination of the one or more latent factors is based, at least in part, on a semantic analysis of the one or more tags.

46. A method of claim 45, wherein the (1) data and/or (2) information and/or (3) at least one signal are further based, at least in part, on the following:
at least one determination of correlation information of the one or more tags to the one or more latent factors; and
a selection of at least one subset of the one or more tags to represent respective semantic meanings of the one or more semantic spaces, one or more dimensions of the one or more semantic spaces, or a combination thereof based, at least in part, on the correlation information.

47. A method of claim 42, wherein the (1) data and/or (2) information and/or (3) at least one signal are further based, at least in part, on the following:
a distribution of the one or more tags with respect to the one or more users, the one or more items, or a combination thereof,
wherein the one or more probability parameters are based, at least in part, on the distribution, a normalization of the distribution, or a combination thereof.

48. A method of claim 42, wherein the (1) data and/or (2) information and/or (3) at least one signal are further based, at least in part, on the following:
a processing of the one or more semantic spaces to cause, at least in part, a modeling of one or more user-tag relationships, one or more item-tag relationships, one or more user-item rating relationships, or a combination thereof,
wherein the one or more probability parameters are based, at least in part, on the modeling.

49. A method of claim 48, wherein the modeling is based, at least in part, on a probabilistic matrix factorization model.

50. A method of claim 48, wherein the one or more user-tag relationships, the one or more item-tag relationships, the one or more user-item rating relationships are one or more projections of the one or more semantic spaces.

51. A method of claim 42, wherein the (1) data and/or (2) information and/or (3) at least one signal are further based, at least in part, on the following:
at least one determination to estimate at least one of the one or more probability parameters by fixing other ones of the probability parameters and applying at least one convex optimization.

52. A method comprising:
determining one or more tags associated with one or more items, wherein the one or more tags are generated by one or more users;
processing and/or facilitating a processing of the one or more tags to cause, at least in part, a generation of one or more semantic spaces, wherein the one or more semantic spaces represent one or more groupings of the one or more tags;
determining one or more probability parameters that the one or more tags, the one or more users, the one or more items, or a combination thereof are associated with the one or more semantic spaces; and
processing and/or facilitating a processing of the one or more probability parameters to cause, at least in part, a calculation of predicted rating information with respect to the one or more tags, the one or more users, the one or more items, or a combination thereof.

53. An apparatus comprising:
at least one processor; and
at least one memory including computer program code for one or more programs,
the at least one memory and the computer program code configured to, with the at least one processor, cause the apparatus to perform at least the following,
determine one or more tags associated with one or more items, wherein the one or more tags are generated by one or more users;
process and/or facilitate a processing of the one or more tags to cause, at least in part, a generation of one or more semantic spaces, wherein the one or more semantic spaces represent one or more groupings of the one or more tags;
determine one or more probability parameters that the one or more tags, the one or more users, the one or more items, or a combination thereof are associated with the one or more semantic spaces; and
process and/or facilitate a processing of the one or more probability parameters to cause, at least in part, a calculation of predicted rating information with respect to the one or more tags, the one or more users, the one or more items, or a combination thereof.

54. An apparatus of claim 53, wherein the apparatus is further caused to:
determine to generate one or more recommendations based, at least in part, on the predicted rating information.

55. An apparatus of claim 53, wherein the apparatus is further caused to:
process and/or facilitate a processing of the one or more tags to determine one or more latent factors,
wherein the one or more groupings are further based, at least in part, on the latent factors.

56. An apparatus of claim 55, wherein the determining of the one or more latent factors is based, at least in part, on a semantic analysis of the one or more tags.

57. An apparatus of claim 56, wherein the apparatus is further caused to:
determine correlation information of the one or more tags to the one or more latent factors; and
cause, at least in part, a selection of at least one subset of the one or more tags to represent respective semantic meanings of the one or more semantic spaces, one or more dimensions of the one or more semantic spaces, or a combination thereof based, at least in part, on the correlation information.

58. An apparatus of claim 53, wherein the apparatus is further caused to:
determine a distribution of the one or more tags with respect to the one or more users, the one or more items, or a combination thereof,
wherein the one or more probability parameters are based, at least in part, on the distribution, a normalization of the distribution, or a combination thereof.

59. An apparatus of claim 53, wherein the apparatus is further caused to:
process and/or facilitate a processing of the one or more semantic spaces to cause, at least in part, a modeling of one or more user-tag relationships, one or more item-tag relationships, one or more user-item rating relationships, or a combination thereof,
wherein the one or more probability parameters are based, at least in part, on the modeling.

60. An apparatus of claim 59, wherein the modeling is based, at least in part, on a probabilistic matrix factorization model.

61. An apparatus of claim 59, wherein the one or more user-tag relationships, the one or more item-tag relationships, the one or more user-item rating relationships are one or more projections of the one or more semantic spaces.

62. An apparatus of claim 53, wherein the apparatus is further caused to:
determine to estimate at least one of the one or more probability parameters by fixing other ones of the probability parameters and applying at least one convex optimization.
